(19) United States
(12) Patent Application Publication
(10) Pub. No.: US 2017/0100957 A1
(43) Pub. Date: Apr. 13, 2017

(54) Decorated pencil

(71) Applicant: Niren Patel, Plano, TX (US)

(72) Inventor: Niren Patel, Plano, TX (US)

(21) Appl. No.: 14/877,735

(22) Filed: Oct. 7, 2015

(51) Int. Cl. B43K 19/14; B43K 19/02

(52) U.S. Cl. CPC B43K 19/14; B43K 19/02; B43K 19/145

(57) ABSTRACT

A pencil for writing may include an outer sleeve being a first color; an inner sleeve connected to the outer sleeve being a second color and a lead center rod being connected to the inner sleeve. The first color and the second color may be displayed when the pencil is sharpened.

### FIELD OF THE INVENTION

The present invention relates to a pencil and more particularly to a decorative pencil including a decorative tip.

### BACKGROUND

The design and construction of conventional pencils have been known for a number of years. A central lead rod is usually enclosed by a hollow sleeve/hollow shaft which may be terminated at one end with a band or cap which forms a friction fit with the sleeve and forms a friction fit with an eraser.

In construction, the sleeve is divided into two mirrored sections with the sleeve being formed from a pair of longitudinal half sections. These mirrored sections are joined together around the central lead rod with adhesive or other appropriate material and the cap with the eraser may be applied to an end of the sleeve by a friction fit.

In order to use the pencil, the pencil must be sharpened which usually includes sharpening the lead center rod to a relatively sharp point. Additionally, the sleeve which is formed around the lead center rod must be trimmed back to expose the lead center rod. The sharpening is usually performed by a sharpener which may provide a cone shaped end.

### SUMMARY

A pencil for writing may include an outer sleeve having at least one indicia and a lead center rod being connected to the outer sleeve.

The indicia may be displayed when the pencil is sharpened.

A pencil for writing may include an outer sleeve being a first color; an inner sleeve connected to the outer sleeve being a second color and a lead center rod being connected to the inner sleeve.

The first color and the second color may be displayed when the pencil is sharpened.

The indicia may be a first color and a second color. The indicia may be a first half being a first color and a second half being a second color where the first half and second half enclose the lead center rod and may be a third half being a third color and a fourth half being a fourth color where the third half and the fourth half enclose the first and second half.

The indicia may be a character.

The indicia may be a star or a geometric shape.

The indicia may be a letter.

The indicia may be a number.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a portion of a pencil of the present invention;

FIG. 2 illustrates a cross-section of the portion of the pencil of the present invention;

FIG. 3 illustrates an another portion of an another pencil of the present invention;

FIG. 4 illustrates a cross-section of the portion of the pencil of the present invention;

FIG. 5 illustrates an another portion of an another pencil of the present invention;

FIG. 6 illustrates a cross-section of the portion of the pencil of the present invention;

FIG. 7 illustrates an another portion of an another pencil of the present invention;

FIG. 8 illustrates a cross-section of the portion of the pencil of the present invention;

FIG. 9 illustrates a perspective view of a portion of the pencil of the present invention;

FIG. 10 illustrates an end view of a portion of the pencil of the present invention;

FIG. 11 illustrates a perspective view of the pencil of the present invention;

FIG. 12 illustrates an end view of another pencil of the present invention;

FIG. 13 illustrates an end view of another pencil of the present invention;

FIGS. 14-21 illustrates additional embodiments of the present invention;

FIGS. 22 and 23 illustrates another embodiment of the present invention.

### DETAILED DESCRIPTION

The present invention provides a method and apparatus for forming and displaying indicia 101 on a pencil 100. In one embodiment, FIG. 1 illustrates a portion of a pencil 100 which may include a cone shaped end of the pencil 100 which may have been formed by a sharpener (not shown), and the cone shaped end may include lead center rod 107 which may extend through the pencil body 109 to provide the ability to mark paper (not shown) by the user. The pencil body 109 may include an inner longitudinal sleeve 105 which may enclose the lead center rod 107 except for the portion of the lead center rod 107 which may have been sharpened and an outer longitudinal sleeve 111 which may enclose the inner longitudinal sleeve 105 except for the portion of the outer longitudinal sleeve 111 which may have been sharpened. The longitudinal sleeve may be formed from wood, metal, plastic, paper or other appropriate material. The lead center rod 107 may be formed from graphite or other suitable material which will mark paper or other forms of writing surfaces. The inner longitudinal sleeve 105 and the outer longitudinal sleeve 111 may be formed from wood, compressed paper or other material which may be colored. The inner longitudinal sleeve 105 may be dyed a first color, and the outer longitudinal sleeve 105 may be dyed a second color where the first color is different than the second color. As a consequence, when the pencil 100 is sharpened and outer sleeve portion 113 of the outer sleeve 111 which is now exposed after sharpening to be seen by the user is a second color and the inner sleeve portion 115 of the inner sleeve 105 which is now exposed after sharpening to be seen by the user is a first color. The indicia 101 may be the combination of the first color and the second color. The indicia 101 may include three or more colors involving additional sleeves which may be dyed a first second and third color.

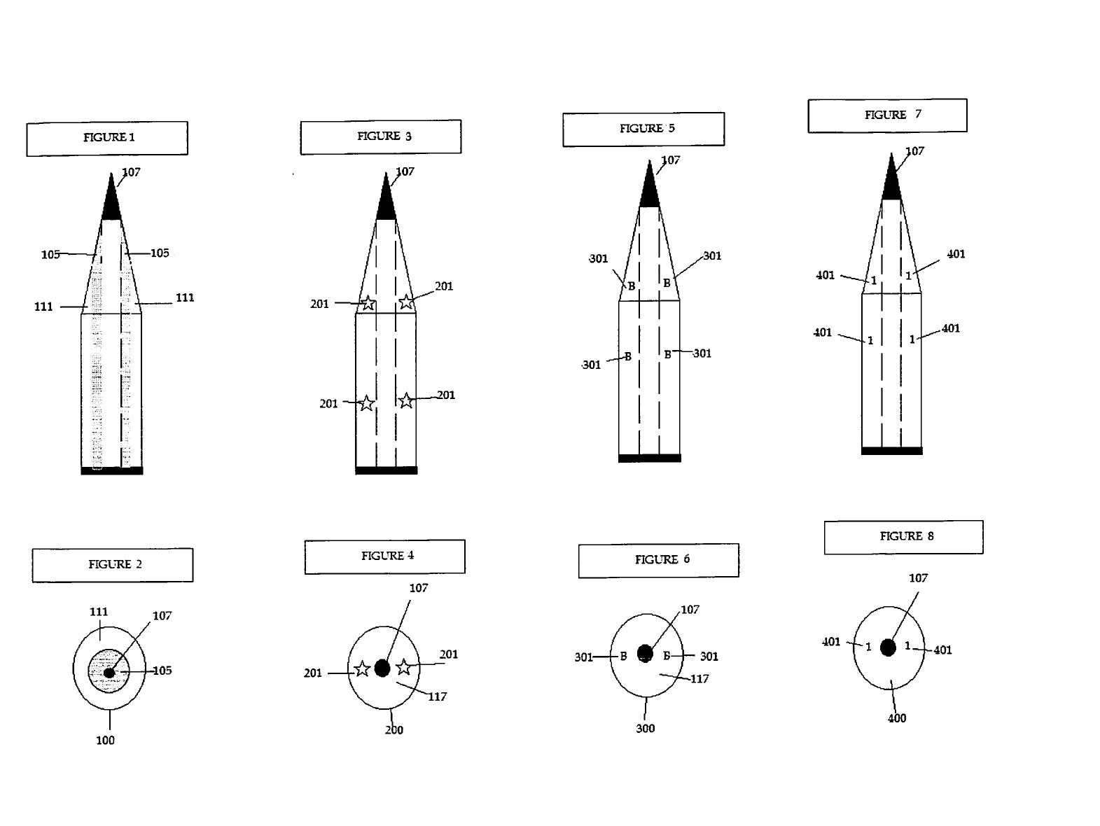

FIG. 2 illustrates an end view of the pencil 100 and illustrates the lead center rod 107, the inner sleeve 105 and the outer sleeve 113.

FIG. 3 illustrates another embodiment of the present invention where the indicia 201 may be a character or symbol such as a star. The pencil 200 may include a single sleeve 117 which may enclose the lead center rod 107, and the single sleeve 117 may have the indicia 201 dyed into the interior of the single sleeve 117 and the indicia 201 may be displayed to the user when the pencil 200 is sharpened.

FIG. 4 illustrates an end view of the pencil 200 and illustrates the lead center rod 107, the single sleeve 117 and the indicia 201.

FIG. 5 illustrates another embodiment of the present invention where the indicia 301 may be a letter or symbol such as a ‘B’. The pencil 300 may include a single sleeve 117 which may enclose the lead center rod 107, and the single sleeve 117 may have the indicia 301 dyed into the interior of the single sleeve 117 and the indicia 301 may be displayed to the user when the pencil 300 is sharpened.

FIG. 6 illustrates an end view of the pencil 300 and illustrates the lead center rod 107, the single sleeve 117 and the indicia 301.

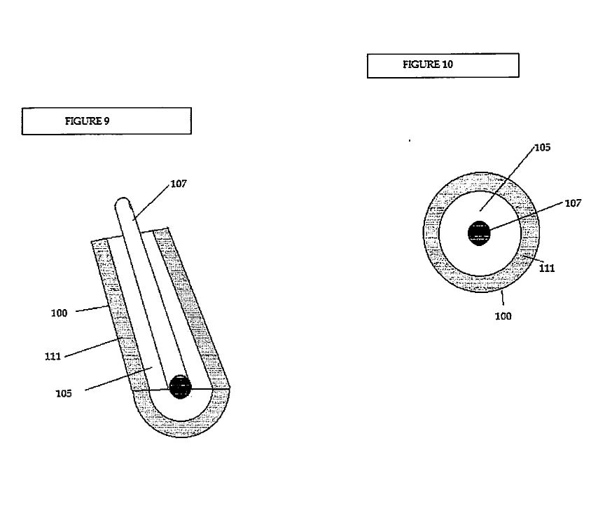

FIG. 7 illustrates another embodiment of the present invention where the indicia 401 may be a number or symbol such as a ‘1’. The pencil 300 may include a single sleeve 117 which may enclose the lead center rod 107, and the single sleeve 117 may have the indicia 401 dyed into the interior of the single sleeve 117 and the indicia 401 may be displayed to the user when the pencil 300 is sharpened.

FIG. 8 illustrates an end view of the pencil 300 and illustrates the lead center rod 107, the single sleeve 117 and the indicia 301.

FIG. 9 illustrates an exploded view of a portion of a pencil 100 which may include the pencil body 109 which may include an inner longitudinal sleeve 105 which may enclose the lead center rod 107 except for the portion of the lead center rod 107 which may have been sharpened and an outer longitudinal sleeve 111 which may enclose the inner longitudinal sleeve 105 except for the portion of the outer longitudinal sleeve 111 which may have been sharpened. The lead center rod 107 may be formed from graphite or other suitable material which will mark paper or other forms of writing surfaces. The inner longitudinal sleeve 105 and the outer longitudinal sleeve 111 may be formed from wood, compressed paper or other material which may be colored. The inner longitudinal sleeve 105 may be dyed a first color, and the outer longitudinal sleeve 105 may be dyed a second color where the first color is different than the second color. The indicia 101 may be the combination of the first color and the second color. The indicia 101 may include three or more colors involving additional sleeves which may be dyed a first second and third color.

FIG. 10 illustrates a cross-sectional view of the pencil 100 of the present invention and illustrates the lead center rod 107, the inner sleeve 105 and the outer sleeve 111.

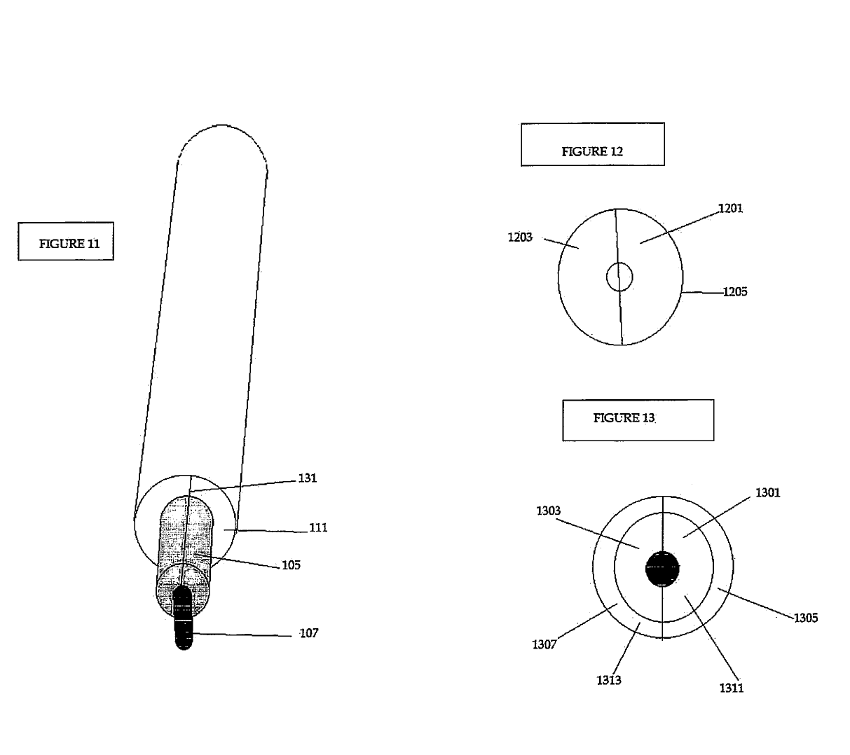

FIG. 11 illustrates a perspective view of the pencil 100 of the present invention and illustrates the lead center rod 107 being joined at the seam 131, the two mirrored sections of the inner sleeve 105 and the two mirrored sections of the outer sleeve 111 being joined at the seam 131.

FIG. 12 illustrates an another pencil 12 00 of the present invention a first half 1201 of the longitudinal sleeve 1205 may be dyed a first color and the second half 1203 of the longitudinal sleeve 1205 may be dyed a second color where the first color is different than the second color.

FIG. 13 illustrates another pencil 1300 of the present invention which may include an inner longitudinal sleeve 1311 and outer longitudinal sleeve 1313 which may extend around the center longitudinal sleeve 1311. The inner longitudinal sleeve 1311 may include a first half 1301 which may be dyed a first color and a second half 1303 which may be dyed a second color where the first color is different than the second color. The outer longitudinal sleeve 1313 may include a third half 1305 may be dyed a third color and a fourth half 1307 which may be dyed a fourth color where the third color is different than the first, second and fourth color and the fourth color is different than the first, second and third color.

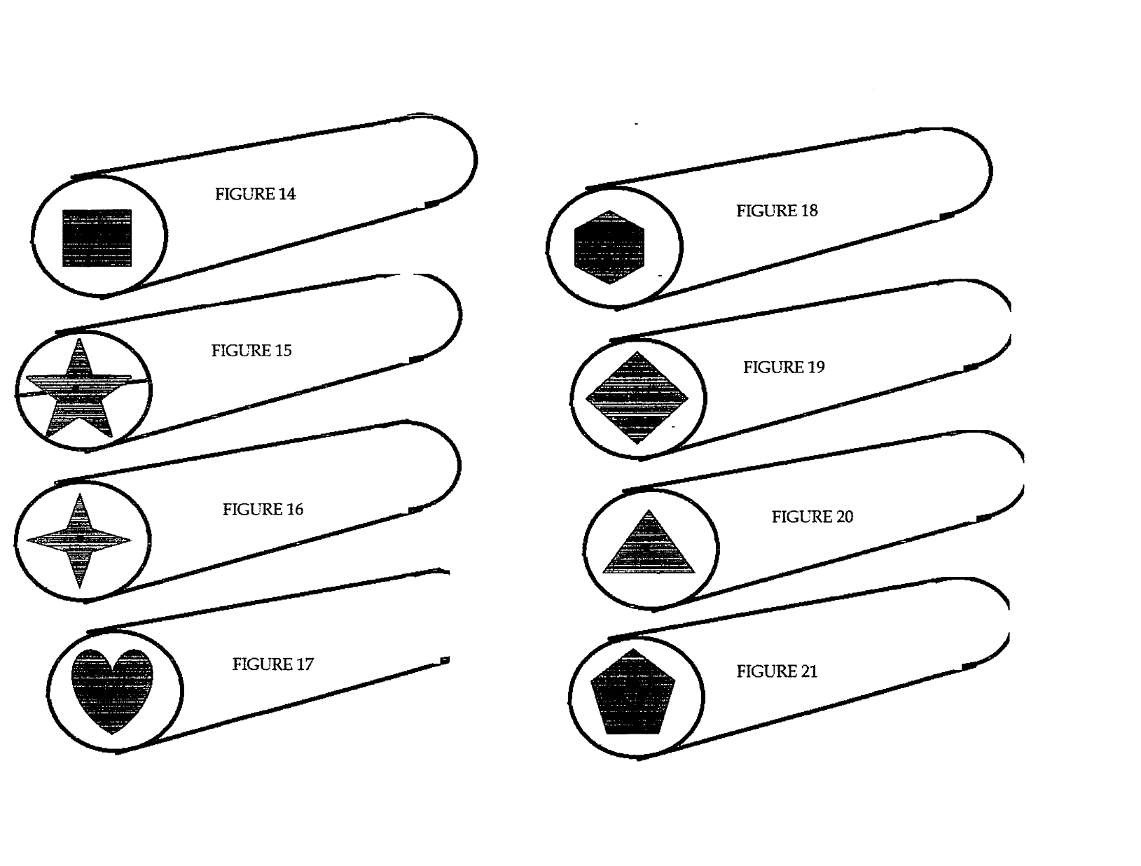

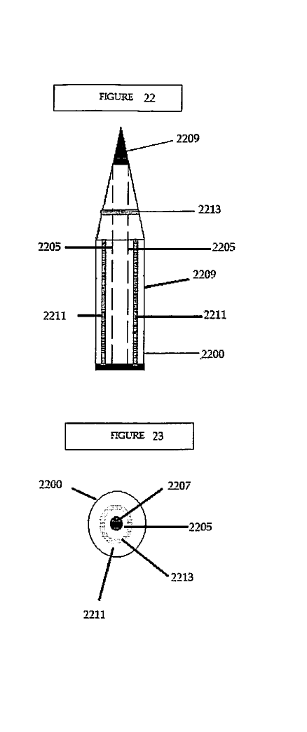

FIGS. 14-21 illustrate additional embodiments of the present invention showing different indicia.

FIGS. 22 and 23 illustrates a portion of a pencil 2200 which may include a cone shaped end of the pencil will 2200 which may have been formed by a sharpener (not shown), and the cone shaped end may include lead center rod 2207 which may extend through the pencil body 2209 to provide the ability to mark paper (not shown) by the user. The pencil body 2209 may include an inner longitudinal sleeve 2205 which may enclose the lead center rod 2207 except for the portion of the lead center rod 2207 which may have been sharpened and an outer longitudinal sleeve 2211 which may enclose the inner longitudinal sleeve 2205 except for the portion of the outer longitudinal sleeve 2211 which may have been sharpened. The longitudinal sleeve may be formed from wood, metal, plastic, paper or other appropriate material. The lead center rod 2207 may be formed from graphite or other suitable material which will mark paper or other forms of writing surfaces. The inner longitudinal sleeve 2205 and the outer longitudinal sleeve 2211 may be formed from wood, compressed paper or other material which may be colored. The inner longitudinal sleeve 2205 may be dyed a first color, and the outer longitudinal sleeve 2205 may be dyed a second color where the first color is different than the second color. Additionally, the pencil 2200 may include a cylinder/disk/ring 2213 of material that may be dyed a third color and may be centered on the lead 2207.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A pencil for writing, comprising:
an outer sleeve having at least one indicia;
a lead center rod being connected to the outer sleeve;
wherein the indicia is displayed when the pencil is sharpened.

2) A pencil for writing, comprising:
an outer sleeve being a first color;
an inner sleeve connected to the outer sleeve being a second color;
a lead center rod being connected to the inner sleeve;
wherein the first color and the second color are displayed when the pencil is sharpened.

3) A pencil for writing as in claim 1, wherein the indicia is a first color and a second color.

4) A pencil for writing as in claim 1, wherein the indicia is a character.

5) A pencil for writing as in claim 4, wherein the indicia is a star.

6) A pencil for writing as in claim 1, wherein the indicia is a letter.

7) A pencil for writing as in claim 1, wherein indicia is a number.
